(19) United States
(12) Patent Application Publication
(10) Pub. No.: US 2009/0093044 A1
(43) Pub. Date: Apr. 9, 2009

(54) METHOD FOR TREATING ORGANIC MATTER TO PROMOTE MOULDERING

(75) Inventor: Susanne Wiigh-Masak, Nosund (SE)

Correspondence Address: GAUTHIER & CONNORS, LLP, 225 FRANKLIN STREET, SUITE 2300, BOSTON, MA, 02110, US

(73) Assignee: PROMESSA AB, Nosund (SE)

(21) Appl. No.: 12/334,567

(22) Filed: Dec. 15, 2008

Related U.S. Application Data
(63) Continuation of application No. 11/272,251, filed on Nov. 10, 2005.
Application No. 11/272,251 is a continuation-in-part of application No. 10/160,720, filed on Jun. 3, 2002, now abandoned.
Application No. 10/160,720 is a continuation of application No. PCT/SE00/02429, filed on Dec. 4, 2000.

(30) Foreign Application Priority Data
Dec. 3, 1999 (SE) 0101996-7
Dec. 3, 1999 (SE) 9904433-1

(51) Int. Cl. A01N 1/00; C02F 3/00

(52) U.S. Cl. 435/262; 27/21.1

(57) ABSTRACT

The present invention relates to a method for treating organic matter to promote mouldering wherein the organic material is subjected to a splitting process followed by a freeze drying process prior to being transferred for deposition for mouldering.

### TECHNICAL FIELD

The present invention relates to a method for treating organic matter to promote mouldering after freeze drying.

### BACKGROUND OF THE INVENTION

Organic matter can be treated in different ways to be able to be used as a nutritional source. In conventional composts, organic matter such as garden clippings, leafs, or kitchen sewage, is put into a compost vessel and in the presence of oxygen, different micro organisms, wood-lice, worms and other small animals will decompose the material to a nutritionally rich soil, so that plants can utilize the nutritional contents of the material, once again.

As mentioned above such mouldering takes place in the presence of oxygen, this requires the compost to not have any content more than about 25 cm from an airing surface. In well-functioning composts there is no putrefaction taking place and the leaving gas is only steam and carbon dioxide, as well as nitrogen gas in some circumstances. The temperature of a normal compost is about 30-35° C. which provides for an optimal mouldering. However, during winter time when the temperature falls, the process rate decreases, but nevertheless the mouldering continues.

The term “hot-compost” indicates that the compost works at very elevated temperatures 60-70° C. This means that it is not a pure mouldering process taking place as worms, wood-lice and a great part of the micro organisms do not feel comfortable at such high temperatures, and the decomposition takes place via heat resistant micro organisms only. The decomposition is altogether slower and takes place as a putrefying process, producing gases with bad smells.

Composting of house-hold waste may also contribute to drawbacks in the form of rats and mice which are tempted to the compost if the mouldering does not proceed fast enough. The greatest problem occurs of course when more complex structures shall be composted such a slaughter and hunting wastes.

During soil burials of a human body, the body is placed at a depth of 180-200 cm. However, at this depth there is an absence of oxygen with no mouldering taking place, but rather a putrefaction under the influence of sulphur producing micro organisms. The rotten body will float away in the form of a liquid from the grave cavity. Neither the soil nor the plants will be able to assimilate the nutritional content of the organic part of the body. This tradition of burying humans at large depths dates back several hundreds of years in time, and was of course a way to stop animals from digging up the body after a burial.

During the cremation process the body is burned at high temperatures and the remains consist of mineral rich ashes which can be deposed in an urn, or as often today, be spread in a memorial park. When the ashes are spread in a memorial park they will dissolve during rain falls, or other type of down falls, and the mineral salt solution produced will flow away and penetrate into the deeper soil layers without being able to be assimilated by the surrounding ground vegetation. Besides this drawback, the contribution of carbon dioxide to the green house effect as well as released gaseous mercury from teeth fillings upon burning, cremation cannot be recommended from an environmental point of view.

There is a belief that we shall return to earth, which is reflected in the expression “Earth to earth, ashes to ashes, and dust to dust” of the burial ceremony, providing the basis for many peoples life philosophy. Facts show, however, that we do not return to earth but flow away in liquid state. Today there is no efficient way of burying a human body so that the remains moulder and the nutritional contents of the organic matter can be assimilated by the ground vegetation.

U.S. Pat. No. 4,067,091 discloses a process for freeze drying a human body to prepare it for an earth burial, and where the object is to provide a moulderable remain. The process is carried out by first deep freezing the body in order to treat the body at a temperature of below −100° C., secondly to mechanically disintegrate the body into particulate form using e.g., a hammer mill, and third to freeze dry the particles for removing 95% of the water content and subsequently depose the remains from the freeze drying. Disintegration of a human body with a hammer mill in this way prior to freeze drying is, however, not ethically defendable.

DE-A-3,842,341 discloses a process for dewatering animal carcasses and/or chicken eggs by means of freeze drying at temperatures between −15 and −30° C. and a pressure of between 1×10² and 3×10² Pa, optionally after disintegration at a temperature of 15-25° C. The freeze dried mass can then be stored at room temperature, be burned or be used as a fertilizer.

Thus, there is a need for a process to treat organic matter, such as material from plant and/or animal origin so that it can be mouldered in a natural way, as well as in an ethically correct way, when so requested.

### SUMMARY OF THE PRESENT INVENTION

The present invention discloses a process for treating organic matter to promote mouldering, wherein the organic material is subjected to a splitting process in which the tissue structure of the material is changed so that it will include channels or fractures through which water can sublimate during a subsequent freeze drying process prior to the transferral for deposition for mouldering.

In one preferred embodiment the organic material is subjected to a splitting process by means of rapid deep freezing of the organic material to −190° C. by submersion of the material in liquid nitrogen.

In one preferred embodiment the deep freezing is optionally followed by a perforating treatment in the form of high pressure water jets, preferably airless, high pressure liquid nitrogen, high pressure steam, high energy laser or a stream of vegetable oil under high pressure.

In one preferred embodiment the perforation takes place from at least two sides, suitably arranged perpendicular to each other.

In one preferred embodiment the freeze drying is carried out during simultaneous influence of ultra sound.

In one preferred embodiment the organic material is a human body.

In one preferred embodiment the organic material is slaughter waste.

In one preferred embodiment the organic material is household/kitchen waste.

In one preferred embodiment the organic material is fish and/or shell fish waste.

Further characteristics are evident from the accompanying claims.

### DETAILED DESCRIPTION OF THE PRESENT INVENTION

It is now possible to solve the above discussed problem by means of the present invention which is characterized in that the organic material is subjected to a splitting process followed by freeze drying before transfer for deposition for mouldering.

The term “splitting process” is intended to mean that the body is fractured into smaller parts. This can be achieved by subjecting the organic material to such a rapid and large freezing that the tissue structure does no longer stick together but exhibits cracks and ruptures. In order to obtain the optimal cracking during freezing it is of uttermost importance that the freezing is rapid. Rapid freezing does not allow enough time for water to diffuse from the cells and freeze extracellularly—and it is intracellular freezing that causes the most damage. With faster freezing, the ice crystals that are formed are smaller, which is advantageous. Slower cooling rates allow molecules time to minimize “free volume”.

Such freezing can be carried out using liquid nitrogen having a boiling point of about −190° C. Thus, the splitting process does not necessarily mean a fragmentation into a particulate form but rather that the tissue material exhibits a structure which has acquired channels or fractures through which water can sublimate in a simple way.

The deep freezing can optionally be followed by a further perforation treatment of the organic matter, using water jets of high pressure, preferably airless jets (i.e., without any addition of air), high pressure liquid nitrogen, high pressure steam or a high energy laser. A high pressure stream of vegetable oil can also replace the water in the foregoing. The perforation treatment shall be carried out using a suitable density and force, and be applied from directions such that the organic material is split up into preferably cubic elements having the side 1 to 2 cm. This requires the perforation to take place in three planes, suitably arranged substantially perpendicular to each other. Primarily, the perforation further takes place along the body to perforate the large connecting tissue structures of the body.

After the splitting into smaller parts, the organic material is freeze dried. The basic idea of freeze-drying is to completely remove water from the organic material, while leaving the basic structure and composition of the material intact. This is achieved without applying the heat necessary for the evaporation process. Instead, the freeze-drying process converts solid water, e.g. ice, directly into water vapor, omitting the liquid phase entirely. This fundamental principle in freeze-drying is called sublimation, the shift from a solid directly into a gas. Just like evaporation, sublimation occurs when a molecule gains enough energy to break free from the molecules around it. Water will sublime from a solid (ice) to a gas (vapor) when the molecules have enough energy to break free but the conditions aren't right for a liquid to form.

Two major factors that determine what phase (solid, liquid or gas) a substance will take: heat and atmospheric pressure. For a substance to take any particular phase, the temperature and pressure must be within a certain range. Without these conditions, that phase of the substance can't exist. At sea level, where the atmospheric pressure is equal to 1 atm and the temperature is between the freezing point (0° C.) and boiling point (100° C.) water exists in a liquid form. If the temperature is increased above freezing while keeping the atmospheric pressure below 0.06 atm the water is warm enough to thaw, but as there isn't enough pressure for a liquid to form, it will form a gas.

During the freeze drying process the organic material is put into a sealed chamber and frozen solid which separates the water from everything around it, on a molecular level, even though the water is still present. A vacuum pump forces the air out of the chamber, lowering the atmospheric pressure below 0.06 atm. Heating units apply a small amount of heat to the organic material, causing the ice to change phase. Since the pressure is so low, the ice turns directly into water vapor. The water vapor flows out of the freeze-drying chamber, past the freezing coil. The water vapor condenses onto the freezing coil in solid ice form, in the same way water condenses as frost on a cold day.

In the present invention the deep frozen and split organic material is subjected to a freeze drying process, whereby the residual amount of water in the freeze dried organic material is less than 1% in most samples.

By means of the present invention it is achieved that freeze drying can take place using reasonable amounts of energy. Calculations made shows that burning requires at least the same or a larger input of energy, to obtain mineral ashes.

A suitable container for deposition for further mouldering can be a moulderable board or container made of peat which can be placed at a depth of about 25 cm underneath the ground surface where mouldering under aerobic conditions will take place.

If one relates to a burial in soil of a deceased, freeze dried person one may, e.g., simultaneously plant a memorial tree close to the burial site, whereby the planted plant will assimilate the mouldering residues.

The invention will be described in the following more in detail with reference to the accompanying drawing, wherein

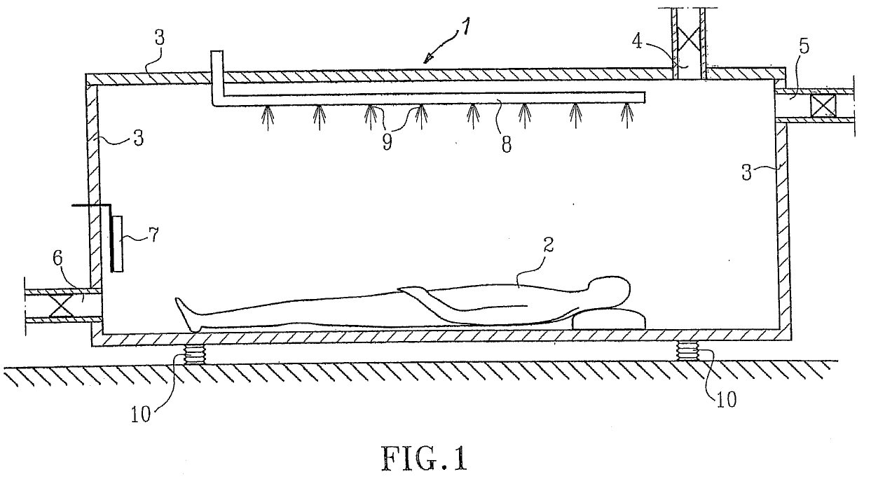

FIG. 1 shows a schematic side view of a device for freeze drying of a person where the device comprises a larger vessel 1 providing room for a dead body 2 and having surrounding walls and lid/roof 3 to be able to completely enclose the body 2 in liquid nitrogen. The walls 3, in this example, comprise elements for receiving sublimated water, i.e., chilled contact surfaces. The lid 3 of the device 1, which in this embodiment further serves as an introduction opening, is provided with a connecting line 4 to a vacuum source (not shown) which is able to bring the whole device under vacuum. Further, the vessel 1 is provided with inlet and outlet lines 5, 6 for liquid nitrogen. Optionally, an ultra sonic probe 7 is placed into the vessel in order to be able to transfer an ultra sound to the content of liquid nitrogen and the organic matter submersed therein, thereby being able to speed up the sublimation of water. The device may also comprise a vessel 1 which is a channel vessel with a device for continuous in and out transport of organic material, in order to be able to obtain a continuous freeze drying of organic material.

To the lid 3 there is further arranged a series of high pressure lines 8 having nozzles 9 for being able to carry out a perforation of a body 2 introduced into the vessel 1, using high pressure steam.

Underneath the vessel 1 are arranged feet 10, which can be vibrated. These feet 10 are arranged to provide a shake chock of the material having been treated after freeze drying so that the material collapses and can be collected in a simple way for further packing in a moulderable container (not shown).

The organic material to be treated, either it consists of a dead human body, slaughter waste or common kitchen waste, is deep frozen by submersing it into liquid nitrogen, −190° C., resulting in a spontaneous formation of cracks and fractures. In the case of human bodies or slaughter waste, cracks will appear in both bone and muscle tissue. To promote further rupture of the tissue, the material can optionally be subjected to a perforation treatment using high pressure steam as discussed above. While still in the deep frozen state, the ruptured material is placed in a vessel equipped for freeze drying wherein the water contained in the deep frozen organic material is allowed to sublime to a condensing surface, optionally via a passage in a warmer stream of air having greater ability of carrying moisture. In order to support the sublimation the material can be subjected to ultra sound treatment.

When the calculated amount of water has been removed which is simply determined by controlling the amount of water condensed, the material is subjected to a shake chock, whereby the material collapses, is collected and put for deposition.

### Test

Drying has been performed on beef and pork meat as well as pork fat and pork legs using the procedure described above. Treatment using submersion in liquid nitrogen resulted in the formation of fractures in both bone and muscle tissue. The spontaneous splitting of the meat is facilitated by the extremely rapid cooling of the treatment using liquid nitrogen. The material was further perforated into 1-2×1-2×1-2 cm large cubes. Freeze drying was carried out in a conventional laboratory freeze drier at −50° C. and by using a vacuum of 1×10² Pa.

A total of 10 different tests were carried out, four of which are shown in Table 1 below. The original weight, fat and water content of the starting material as well as the weight of the dried remains and the amount of water evaporated by the process was determined by a chemical laboratory. The results show that all water registered as water content before the treatment was found eliminated at the end of the procedure.

TABLE 1

| Before freeze drying | | | | | After freeze drying | | |
|---|---|---|---|---|---|---|---|
| | Original | Fat | | | Dried | Amount of | |
| | weight | content | Water content | | remains | evaporated water | |
| Test | (g) | (%) | (g) | (%) | (g) | (g) | (%) |
| 1 | 61.19 | 22.97 | 36.46 | 59.58 | 24.46 | 36.73 | 100.70 |
| 2 | 167.77 | 22.35 | 100.29 | 59.78 | 68.48 | 99.29 | 99.00 |
| 3 | 38.64 | 33.91 | 20.08 | 51.97 | 18.58 | 20.06 | 99.90 |
| 4 | 142.13 | 31.95 | 74.93 | 52.72 | 67.98 | 74.15 | 98.96 |

As evident from Table 1 above, an almost complete dewatering of the material was obtained.

The material freeze dried as described above is collected in a moulderable container, such as compressed peat, paper, cardboard, board or the similar and is placed in a suitable site in soil and at a depth of up to 25 cm. In connection with a re-hydration and influence by micro organisms, insects, worms, and small animals, the material moulders in an odourless way to yield soil having a high nutritional value, which can be assimilated by nearby vegetation.

Optionally, as the freeze dried material is lightly hygroscopic the container can suitably be provided with a water tight layer, such as an easily decomposable starch polymer, so called corn plastic, which forms an effective water barrier when the product is stored above ground.

Any organic material which is very rapidly decomposed under simultaneous production of odours, such as for example fish and shellfish wastes are very suitable for the present treatment, wherein the water content can be lowered to a few percent followed by a composting of the material, optionally after a pre-packing in a moulderable container.

1. A process for treating organic matter to promote mouldering, wherein the organic material is subjected to
a) a splitting process in which the tissue structure of the material is changed so that it will include channels or fractures through which water can sublimate, which channels are prepared by a perforating treatment in the form of high pressure liquid nitrogen,
b) a subsequent freeze drying process, and
c) a transferral for deposition for mouldering.

2. A process according to claim 1, wherein the splitting process comprises deep freezing the organic material to −190° C. by submersion of the material in liquid nitrogen.

3. A process according to claims 1 and 2, wherein the deep freezing is followed by a perforating treatment in the form of high pressure water jets, high pressure liquid nitrogen, high pressure steam, high energy laser or a stream of vegetable oil under high pressure.

4. A process according to claim 1, wherein the perforation takes place from at least two sides, of the organic material, which sides are arranged perpendicular to each other.

5. A process according to claim 1, wherein the freeze drying is carried out during simultaneous influence of ultra sound.

6. A process according to claim 1, wherein the organic material is a human body.

7. A process according to claim 1, wherein the organic material is slaughter waste.

8. A process according to claim 1, wherein the organic material is household/kitchen waste.

9. A process according to claim 1, wherein the organic material is fish and/or shell fish waste.

10. A process according to claim 1, wherein the transferral for deposition for mouldering is a burring at a depth of up to 25 cm.
